(19) United States
(12) Patent Application Publication
(10) Pub. No.: US 2007/0098263 A1
(43) Pub. Date: May 3, 2007

(54) Data entry apparatus and program therefor

(75) Inventors: Naohiro Furukawa, Tachikawa (JP); Hisashi Ikeda, Kunitachi (JP); Makoto Iwayama, Tokorozawa (JP); Yusuke Sato, Hachioji (JP); Kosuke Konishi, Hachioji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/484,779

(22) Filed: Jul. 12, 2006

(30) Foreign Application Priority Data
Oct. 17, 2005 (JP) 2005-301125

(51) Int. Cl. G06K 9/00; G09G 5/00; G06F 17/00

(52) U.S. Cl. 382/181; 715/541; 345/179

(57) ABSTRACT

A command interpretation means is provided to allow any arbitrary combination of the method of specifying a character string or an area on a paper or a monitor display with a pen or a mouse, and the method of writing a character string or a symbol which means a command element by a pen, a keyboard, or the like. Furthermore, a command interpretation means is provided to allow an imperfect character in command element extraction. A data entry apparatus disclosed includes: a command element extraction unit which outputs a plurality of recognition candidates for the command element in response to the instruction input from a user, the command rule matching unit, which extracts a command type element out of the plural recognition candidates, and judges the command argument element as an argument for the command type element, and furthermore, determines the combination of a command type element and a command argument element, and a command execution unit, which executes the command of the command type element to the above-determined command argument element. To reduce the limit to a user input becomes possible by taking into consideration of the combination to a plurality of candidates extracted.

### CLAIM OF PRIORITY

The present application claims priority from Japanese application JP 2005-301125 filed on Oct. 17, 2005, the content of which is hereby incorporated by reference into this application.

### FIELD OF THE INVENTION

The present invention relates to a command instruction processing to a system with a digital pen.

### BACKGROUND OF THE INVENTION

When information retouch is performed to a paper or the like, there is a digital pen available which can reflect the data as an electronic data such as disclosed in WO 2001/71473. In this use a user inputs (1) an element for the type of command, such as “internet retrieval” or “printing”, and (2) an element for the argument of command, such as a retrieval key word or a printing object range. These elements are hereafter called command elements, and the former is a command type element and the latter a command argument element.

There is a method 1 of interpreting the command including a character entered by a user with a pen and a symbol by using a language analysis, as disclosed e.g. in JP-A No. 282566/1994.

There is another method 2 to interpret a command, which has a lack in its element or a different string in element order, by utilizing a user's history and status information, as disclosed e.g. in JP-A No. 110890/1996.

However, as the specification method of a command element there have not been any means to allow any arbitrary combination of the method for specifying a character string, a region on a paper or a screen with a pen or a mouse and the method for writing a character string or a symbol for the command element with a pen or a keyboard.

Moreover, since all of the above-mentioned prior methods were premised on each command element being inputted with certainty, they had a problem which does not support an imperfect character of a command element extraction. Although in the conventional method 1 the character and symbol constituting a command element are entered with a pen and the command element is extracted by a character and symbol recognition thereof, however, the character and symbol recognition may not always be successful, and in fact, two or more candidates for the recognition may exist, and the recognition result may not be uniquely decided.

For example, it is not uniquely determined whether the character recognition of the entry of “IO” is carried out to be “IO (character)”, or to be “10 (number)” only from this part. Moreover, in the conventional method 2, it is premised on choosing the input of a command element electronically or inputting it by a keyboard, and the imperfect character of command element extraction is not supported. When carrying out command element specification of a corresponding character string, for example, the “net search [symbol] by a [symbol] (check) mark with a pen on a paper, depending on the position and shape of the [symbol] mark, the specification may not be enabled to be judged uniquely whether the element is a “network [symbol] “search [symbol] or “net search [symbol] Since when specifying such a command element especially on space, an interactive interface cannot be used unlike on a monitor display, such as carrying out a reverse video display of the round enclosure or the [symbol] mark for corresponding character string that the computer has recognized. Unless a command interpretation responding to an imperfect character of such command element extraction, a command cannot be properly interpreted with high precision.

### SUMMARY OF THE INVENTION

The present invention is performed in considering such a problem. That is, a command interpretation means is provided to allow an arbitrary combination of a method of specifying a character string and an area on a paper or a monitor display with a pen or a mouse, and a method of writing a character string or a symbol for a command element by a pen, a keyboard, or the like, as a specification method of a command element. Furthermore, in order to enable such a flexible input, it is another object of the present invention to provide a command interpretation means to allow an imperfect character of command element extraction.

In the present invention, in order to solve the objects, the typical invention disclosed is as follows.

An input processing unit includes an input unit which receives a command input from a user, and a command element extraction unit that outputs a plurality of recognition candidates for each of the inputted commands, a command rule matching unit to determine the combination of a command type element and a command argument element, wherein extracting a command type element out of a recognition candidates and further specifying a command argument element which serves as an argument of the command type element, and a command executing unit that executes the command of the command type element for the determined command argument element.

According to the present invention, a user is enabled to execute a required computer command easily with the operation suited to intuition of man while accessing a paper or a screen.

### BRIEF DESCRIPTION OF THE DRAWINGS

FIG. 1 is a block diagram of the command interpreter according to the present invention;

FIG. 2 shows an example of an instruction of a command to a user computer according to the present invention;

FIG. 3 is a drawing to show the specification method for a command element according to the present invention;

FIG. 4 is a diagram to show examples of data structure in the command element dictionary according to the present invention;

FIG. 5 is a drawing to show an example of data structure in a command rule dictionary according to the present invention;

FIG. 6 is a diagram to show an example of data structure of document information according to the present invention;

FIG. 7 is a set of diagrams to show examples of input data structures according to the present invention;

FIG. 8 is a set of diagrams to show examples of data structures for a command element extraction result according to the present invention;

FIG. 9 is a drawing showing an example of data structure of an instruction interpretation result according to the present invention;

FIG. 10 is a schematic flow diagram of the command interpretation processing according to the present invention;

FIG. 11 is a schematic flow diagram of command element extracting processing according to the present invention;

FIG. 12 is a schematic flow diagram of instruction definition processing according to the present invention;

FIG. 13A is an illustrative diagram of an example wherein a user registers a new command with a pen and a paper, according to the present invention;

FIG. 13B is an illustrative diagram to show a dialog on the display for registering a new command, according to the present invention;

FIG. 13C is an illustrative diagram to show a correction procedure in a new command registration, according to the present invention;

FIG. 13D is an illustrative diagram to show a final procedure in a new command registration, according to the present invention;

FIG. 14 is an illustrative diagram of an example of a command interpretation implementable according to the present invention;

FIG. 15 is a schematic illustration of an example of a command interpretation implementable according to the present invention; and

FIG. 16 is a schematic flow illustration of command rule collation according to the present invention.

### DETAILED DESCRIPTION OF THE PREFERRED EMBODIMENTS

Here, an example of the structure of command interpreter of the present invention is explained first. And then, a command interpreter interpreting the command instructed by the user, and the processing flow to execute are explained. Finally, the procedure whereto the user adds an instruction is explained concretely.

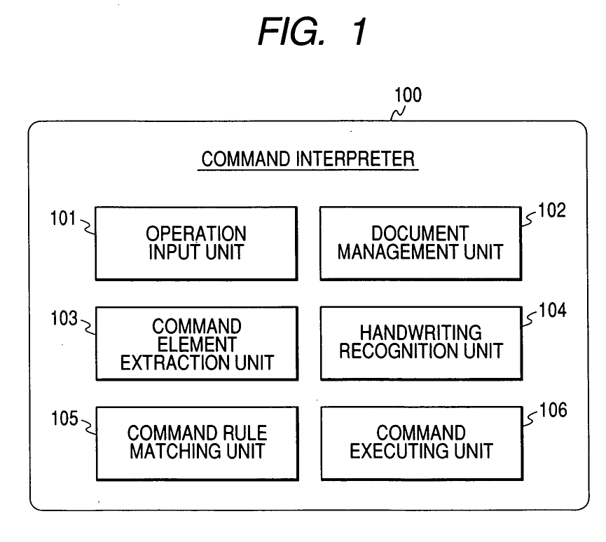

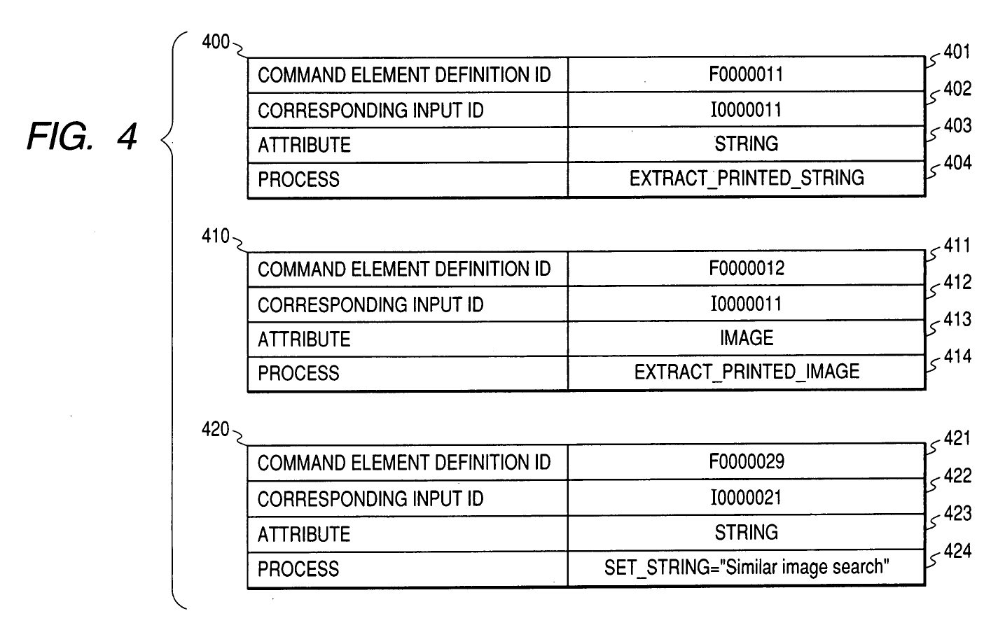

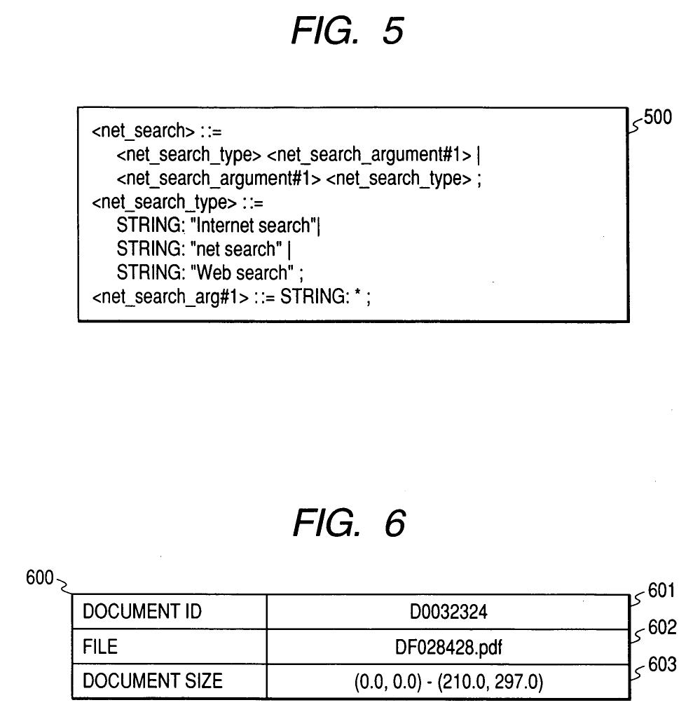

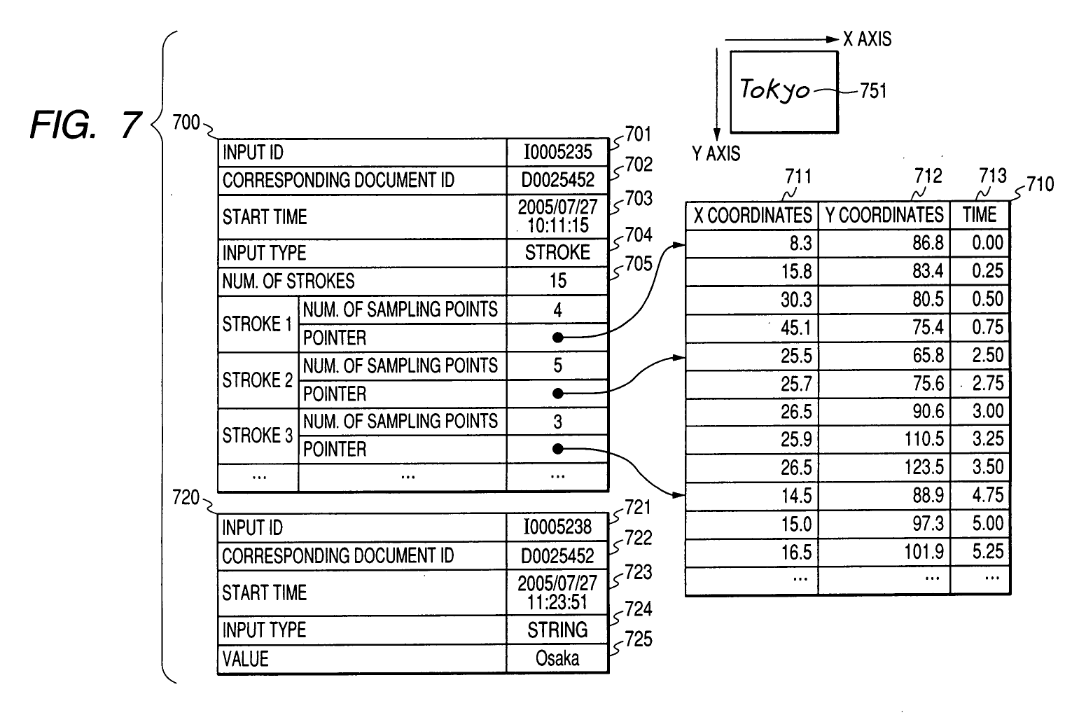

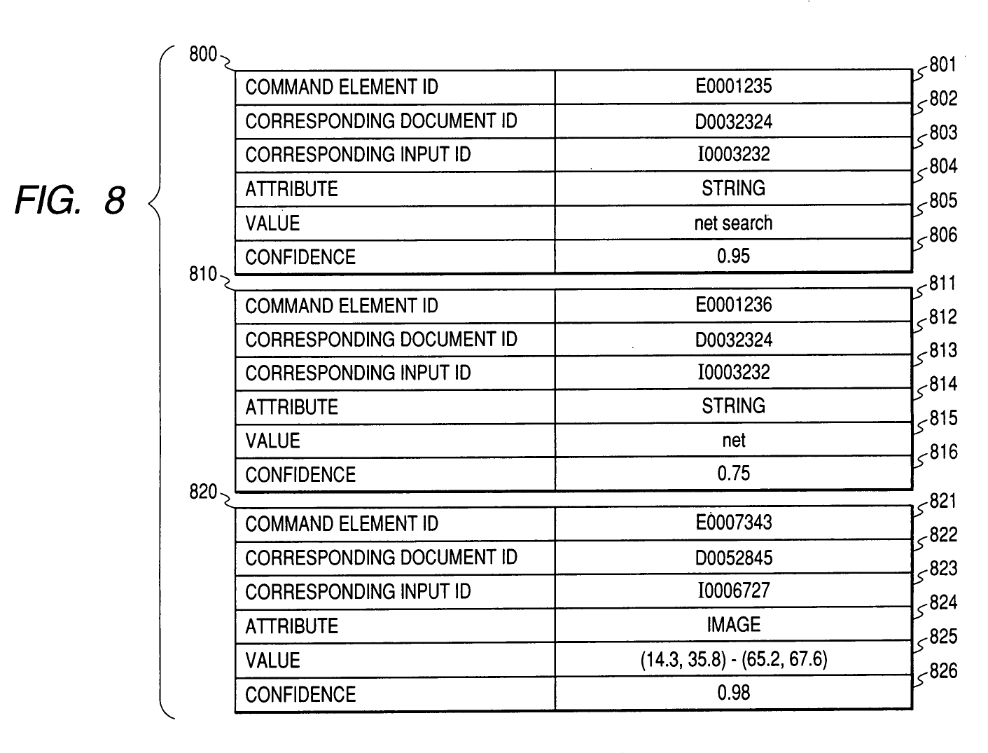

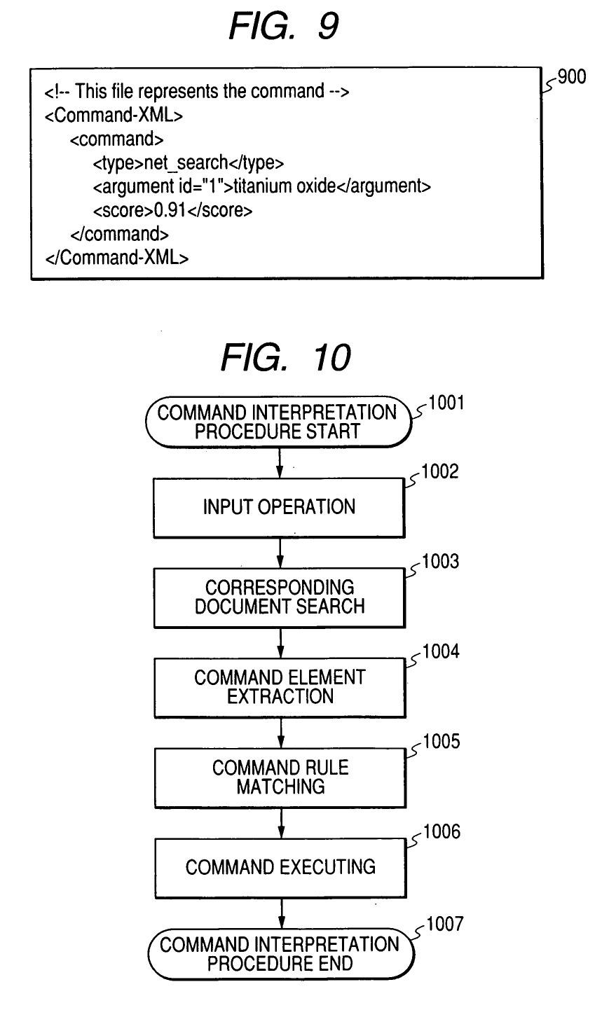

A command interpreter 100 of the present invention comprises the following units as shown in FIG. 1: an operation input unit 101 that acquires various input information, such as a pen operation on a paper, a monitor display, a keyboard operation, or a mouse operation from a user; a document management unit 102 that manages document information (FIG. 6) and the input information (FIG. 7) that the user writes these documents with a pen, or carried out the character string input with the keyboard; a command element extraction unit 103 that extracts a command element with reference to a command element dictionary (FIG. 4), and outputs the result as a set of a command element extraction result (FIG. 8); a handwritten character string recognition unit 104 that reads an inputted pen stroke as a character string; a command rule matching unit 105 that compares the command element extraction result set with a command rule dictionary (FIG. 5), and finds out the string of a command element according to a command rule given in the command rule dictionary, and is outputted as a command interpretation result (FIG. 9); and a command executing unit 106 that executes the command which the user instructed according to the command interpretation result outputted from the command rule matching unit.

As a specification method of a command element in the operation input unit 101, for example, while a user is reading a document, it is assumed to enclose or write the character string or the area for each command element of the command, execution is wanted thereof, with a pen on the paper or monitor the document is printed or displayed thereon. Thus, a user-friendly command interpretation can be realized since the user can execute a command on a computer, without letting the document out of sight.

In the present embodiment, the digital pen disclosed in WO 2001/71473 is adopted as an acquisition means of the pen stroke on a paper. Each paper document has a dot pattern specific to its type and position, so that if a user writes on the paper with the digital pen, the identification information (document ID 601 in FIG. 6) and the entry coordinate can be acquired of the paper document. The electronic file name and the size of the document are denoted by 602 and 603, respectively, in FIG. 6.

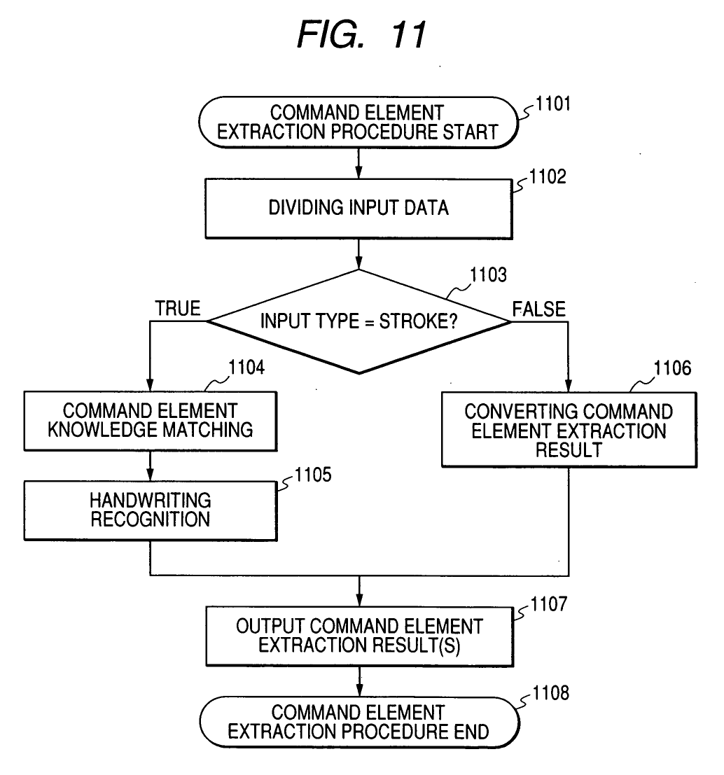

Next, the processing wherein the command interpreter 100 interprets the command from a user is explained specifically (FIG. 10). The input information is acquired (Step 1002) of the instructions with a pen, a keyboard, or the like from the user at the beginning. Next, for an input with the digital pen through paper documents, the documents used as an operation target are searched (Step 1003), and the document information which was the target of operation is acquired. Since ID which discriminates an individual paper from the dot pattern on a paper can be acquired in the case of the digital pen in this embodiment, if the combination of the individual paper ID and document ID is recorded at the time of printing, the document ID (702) can be obtained at the time of pen writing. Next, at Step 1004, the document information and input information are matched with a command element dictionary (FIG. 4), and command elements are extracted, then a set of command element extraction results is obtained (FIG. 8). The details of the command element extraction processing are explained with reference to FIG. 11. And at Step 1005, a set of the command element extraction results and the command rule dictionary (FIG. 5) are compared, a string of command elements according to a command rule described in the rule dictionary is found out, and a command interpretation result (FIG. 9) is obtained. Finally, the command instructed by the user is executed according to the command interpretation result (Step 1006). Hereafter, the details of each step are explained.

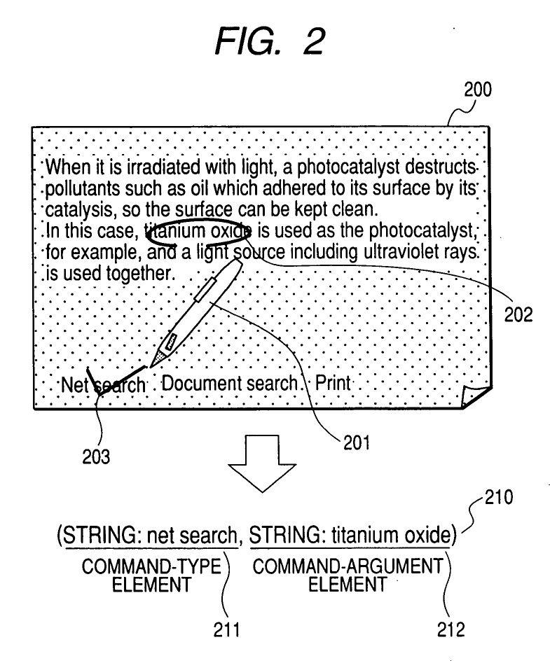

An arbitrary combination is allowed as stated previously as the command specification means from a user to the computer in Step 1002, of the method of specifying the character string and area on a paper or a monitor display with a pen or a mouse, and the method of writing the character string or the symbol for a command element with a pen, a keyboard, or the like. For example, in the paper document 200, FIG. 2 shows an example wherein a user wants to execute a net search of the character string “titanium oxide”, and instructs the command by writing the strokes 202 and 203 on the paper with the pen 201. The command interpreter executes the command interpretation processing shown in FIG. 10, interprets the command 210 including a command element 211 and a command element 212, and executes the command in the command executing unit 106.

The information inputted in the operation input unit 101 is shown in FIG. 7. The case wherein the type of input is a stroke is shown in Table 700. An item 701 represents ID of input information, an item 702 document ID of an input object, an item 703 input start time ID, and an item 704 the type of an input (in this example “STROKE”). Items 701-704 are not based on the type of an input, but are common items. In the case of a stroke, in addition, it has a number of strokes (item 705) and a coordinate string for the sampling point of each stroke (items 711-713). Moreover, it becomes as shown in Table 720 in the case of the character string wherein the type of the input was inputted from a keyboard, or chosen with a mouse. An inputted type serves as a STRING and an item 725 represents the specified character string.

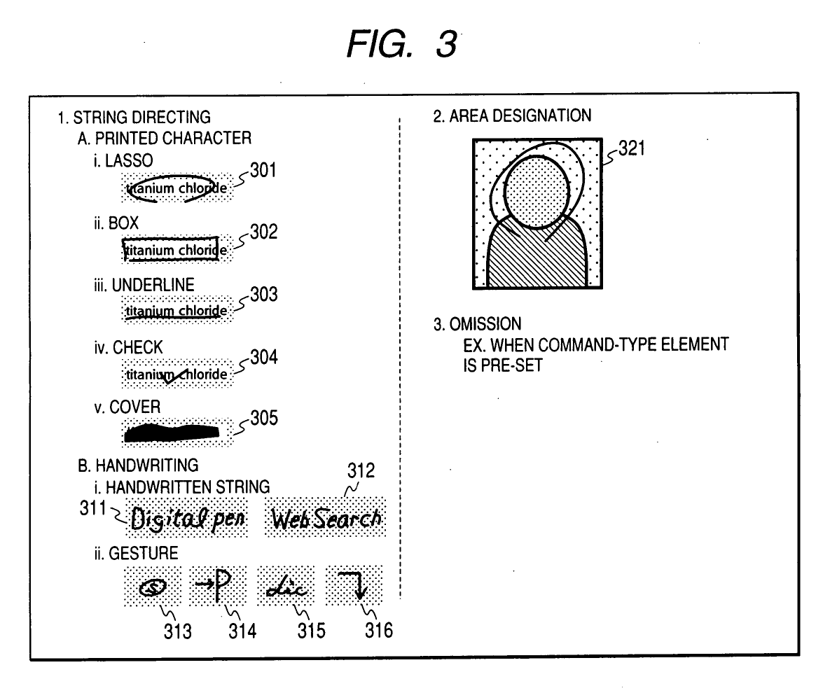

Those methods, for example, as shown by 301-321 in FIG. 3 can be used for the method for specifying a command element with a pen. Methods 301-305 are the examples of the method for specifying the character string printed on a paper or shown on a monitor display. The designation method for the specified character string is not limited to a circle or a rectangle but is assumed to be any arbitrary form. In addition, desirably there may be a retouch of information which can discriminate the specific range from others, such as by drawing a cancellation. Moreover, methods 311-312 are the examples of the method for writing a character string with a pen directly. And, methods 313-316 are methods for recognizing the figures registered beforehand in the command element dictionary to be mentioned later, and extracting a relevant character string instead of writing the character string. Although various figures are assumed as a figure in this case, what suggests the content of a command is most desirable from user-friendliness, if the picture is related to the command element. There is also a method wherein an area is specified to show a part of document printed on a paper or shown on a monitor display, not as a character string as in the method 321. Moreover, in the case where a user instructs a command interpreter 100 about a command with limiting only to a net search, specification of a command type element can be omitted.

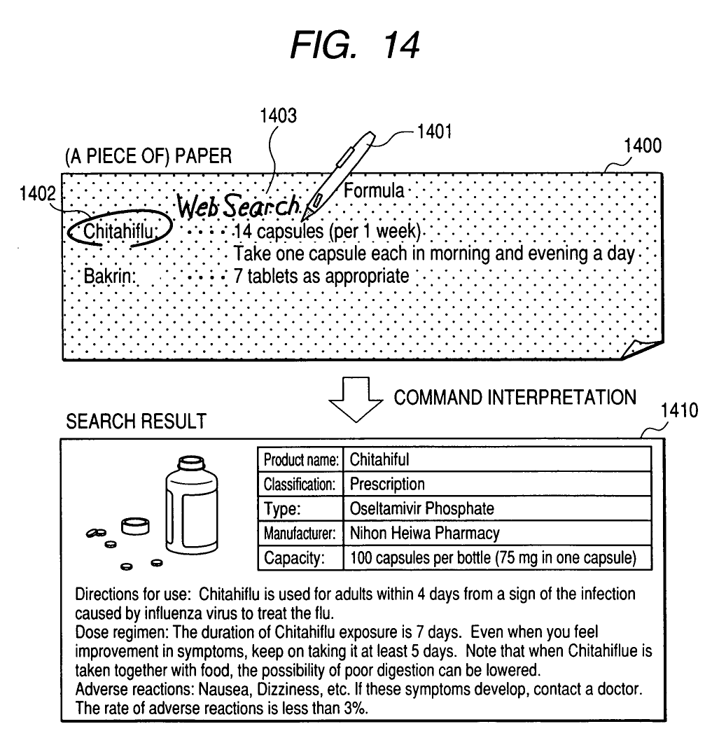

Command element extraction processing (Step 1004 in FIG. 10) divides input information first into command element units using the time feature (Step 1102 in FIG. 11). Furthermore, about the input entered with a digital pen, the geometric feature can be utilized of the arrangement of each stroke and the like (Step 1102). And, if division of a command element is not determined uniquely, a plurality of division candidates can be outputted. For example, in the write-in stroke 1403 in the example of FIG. 14, only a “Web search” is outputted as a division candidate if the entry time interval between “Web” in the first half and “search” in the second half is less than a threshold value α, and both of “Web” and “search” are outputted if the interval is longer than a threshold β, and three of “Web search”, “Web”, and “search” are outputted if the interval is longer than the threshold value a, but shorter than the threshold β (α<β). By the way, if an inputted type is a character string, Step 1102 is not necessary, since the input is already divided into command element units by a return key input or a mouse click operation at the time of keyboard entry or mouse selection.

Next, processing branches depending on whether the input information type (item 704 of FIG. 7) represents a stroke (Step 1103) or not. In the case of a STROKE, collating process of the stroke is executed with a command dictionary (Step 1104), and recognition process is executed for a handwritten character string (Step 1105).

In matching a command element with the element dictionary of Step 1104, matching is made of the form of the input information stroke with the command stroke defined in the element dictionary. The gesture of a command by writing with a pen is defined as shown in Tables 400, 410, and 420 in FIG. 4 in the command dictionary, which the command element extraction unit 103 manages. The gesture stroke stored in the form of the input information becomes the command element, each item of the input ID in question corresponding to the command element definition. Here, the gesture means a specific input stroke which denotes an arbitrary figures or command elements used for indication of an object character string. Writing the character string itself of a command element is excluded. In FIG. 3, each figure is a gesture for the methods 301-305, 313-316, and 321. Methods 311 and 312 are writing of the character string and not gestures, and not registered as gestures in FIG. 4. As a result of matching, if degree of agreement is more than a threshold, then the input is decided to have a possibility to be a command element concerned, and each processing defined by the command dictionary is executed, and the result is outputted as a command element extraction result. As for the processing which the command dictionary can define, three examples of operation are shown: (1) EXTRACT_PRINTED_STRING; extract the printed character sequence within a stroke input area; (2) EXTRACT_PRINTED_IMAGE: extract the printed content of stroke as an image within the stroke input area; (3) SET STRING: extract the command of specified character string on the right-hand side, and output as the command extraction result. As other examples, in order to correspond to the character string specification with an underline, EXTRACT UPPER PRINTED STRING: extract the printed character sequence located in the upper part of the stroke, and the like.

An example is given and explained about Step 1104. The command element definition 400 specifies the character string designation by a round enclosure (301 in FIG. 3), and the command element stroke which can be drawn from the input ID402 is registered with the same round enclosure as the stroke 301 of FIG. 3. As shown in the strokes 301 and 321 in FIG. 3, a plurality of specification methods for command elements may be assigned to the same stroke form. The command element definition 410 is a definition to specify an area by a round enclosure (321 in FIG. 3), and the input ID412 has the same value as that of input ID402 for the command element definition 400, that is, the same stroke form. The command element definition 420 specifies the command element by a gesture, and the command stroke which can be drawn from the input ID422 is registered as the gesture 313 meaning a “similar picture retrieval” in FIG. 3.

If the command element 203 in FIG. 2 corresponds to the command element 400 in the element dictionary, EXTRACT_PRINTED_STRING specified by the item 404 of processing of the element dictionary is executed, the character string “net search” which overlaps the stroke is extracted, and the result is outputted as a command extraction result 800. The reliability of the command extraction result 806 is, in this example, to be computed from the value of (1) degree of stroke coincidence multiplied by (2) overlapping ratio of the extracted character string with the input stroke. By the multiplication, an extraction candidate is more easily chosen with both high indexes for the value.

At this stage, if a plurality of candidates are extracted in Step 1102, then steps 1104 and 1105 are performed to each of the candidates. For example, if the command extraction unit 103 judges that the command element 203 instructed not “net search” but only the portion of the “net” about the input 211 of FIG. 2, the command extraction result 810 is outputted for the same command element 203. The criterion of judgment is decided whether the reliability of the command extraction result exceeds the threshold preset or not. The reason why a plurality of candidates is outputted is for realizing a highly precise command interpretation by responding to the form of pen strokes, such as a round enclosure, or a position deviation robustly. If a command extraction result is judged only from the form and the position of input stroke for each command element, i.e., command element reliability, then in the case of FIG. 8, for example, for “net search” of Table 800, and “network” of Table 810, only the “net search” will certainly be outputted. In the entry example of FIG. 2, although the correct answer is “net search”, a possibility still remains that the user meant the “network” by the same entry as the stroke 203. By outputting all possible candidates with their reliability, a suitable extraction result will be finally chosen by the command rule matching 1005, from these plurality outputted extraction result for one input unit. The reason why a plurality of divided candidates is outputted is similar to the present reason in the previous input division 1102.

In handwritten character string recognition of Step 1105, handwritten character string recognition is performed on the stroke of input to a text, and the result is outputted as a command extraction. For example, the command element 203 is interpreted as the character “V”, which is considered to be most similar to the element, and outputted as a command extraction result. In addition, since the imperfect nature of character string recognition exists also in the step 1105, a plurality of character string recognition results may be outputted as a command extraction result. For example, if the command element 203 obtains character string recognition results, such as “v” of a small letter, and “ [symbol] ” of katakana(Japanese), besides the capital letter “V” mentioned above, it outputs them all as a command extraction result.

In Step 1102, if the input is not stroke information but the character string which was inputted, for example, by the keyboard or chosen with the mouse (example: 720 of FIG. 7), the character string is converted into a command extraction result as it is (Step 1106). To each input, the maximum reliability of 1.0 is given and a command extraction result is created with an attribute of STRING. After this processing, a set of all the obtained command extraction results is handed over to the command rule collating 1005 which is the next processing. The command extraction 1004 is up to this step.

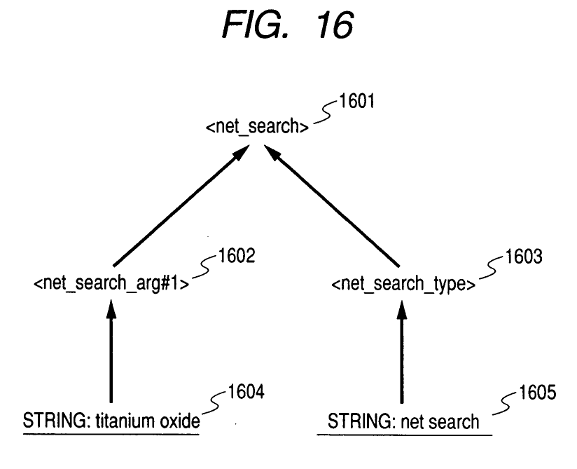

After command extraction, the command rule matching of Step 1005 is the processing that a set of the above-mentioned command extraction results is to be matched with the rule dictionary (FIG. 5), and to find out the sequence of a command element according to a command rule given in the rule dictionary, and then to obtain a command interpretation result (FIG. 9). In the present example, the rule dictionary is described in context of free language as shown in FIG. 5. A regular expression, or an IF-THE N rule, and the like may be prescribed. The command rule 500 specifies the syntax of a command <net_search>, and <net_search> is prescribed by the combination with <net_search_type> and <net_search_arg#1>, or its reverse order (the 1-3 line of the command rule 500). <net_search_arg#1> shows the argument element of a command. It means that the order of appearance does not matter for a command type element and a command argument element in such description. With this rule, a user is enabled to input freely, without being troubled by the turn of a command and an instruction object. Next, the <net_search_type> specifies one of the character strings “internet search”, “net search” or “Web search” (the 4-7 line of the command rule 500). The <net_search_arg#1> specifies arbitrary character strings (the 8 line of the command rule 500). For such a command rule 500, command rule matching is executed whereto a bottom-up process parsing algorithm is applied. That is, if each command extraction result in a set of command extraction results is replaced according to the command rule, and the final command is reached (FIG. 16), then the command is considered to be interpreted. Here, for example, since the command extraction result STRING:net search is a character string, replacement is possible also as <net_search_arg#1>; however, since the interpretation which arrives at a command as a whole does not exist by this replacement, this command extraction result is not chosen after all. The command extraction result of the above-mentioned STRING: net is also not chosen, since the result cannot be similarly interpreted as a whole. Specifically, although a plurality of command extraction results sometimes may be obtained from one command element 203 as shown in Table 800 and Table 810 in FIG. 8, if the “network” of Table 810 is made as an extraction result 1605, since neither the extraction result 1604 nor 1605 is a command element to represent a command type, there exists no command rule which agrees with the command rule collating 1005. Therefore, “net search [symbol] of Table 800 remains as an extraction result 1605. About the command element 202, extraction results, such as “oxidization [symbol] and “titanium [symbol] also exist in addition to a “titanium oxide [symbol] Since “oxidization [symbol] and “titanium [symbol] can serve as a command argument element from the command rule, the command consisting of the combination of a command argument element and a command type element “net search [symbol] is also outputted from the command rule matching 1005. If the reliability of the extraction results of these command argument elements is computed, the reliability of the overlap ratio of a round enclosure for the “titanium oxide [symbol] becomes the highest. In the present example, the reliability of a command interpretation result is defined to be a product of the reliability for each command element. Because all command interpretation results have a command type element “net search ( [symbol] )” in this example, the reliability of the command interpretation result having “titanium oxide” as a command argument becomes the highest.

In the present example, a command interpretation result is outputted in the form of XML as shown in FIG. 9. An XML file is created by tagging the command type element of a command interpretation result by <type>, and tagging each command argument element by <argument>, respectively. In addition, if a plurality of command interpretation results are outputted from a set of a command element extraction results, they are aligned by reliability (value of the tag score in 900 of FIG. 9), and the first, i.e. the top place or a plurality of candidates with reliability larger than a preset threshold are outputted.

The command execution 1007, the command interpretation result 900 is inputted thereto, executes the corresponding command. If a plurality of interpretation results are outputted for this case, the interpretation result of the first place may be performed automatically, or the list of these interpretation results is displayed and the user may choose one therefrom. Moreover, a relative threshold type may be also introduced wherein the first one is performed automatically, if the difference in reliability between the first and the second place interpretation results is more than the preset threshold.

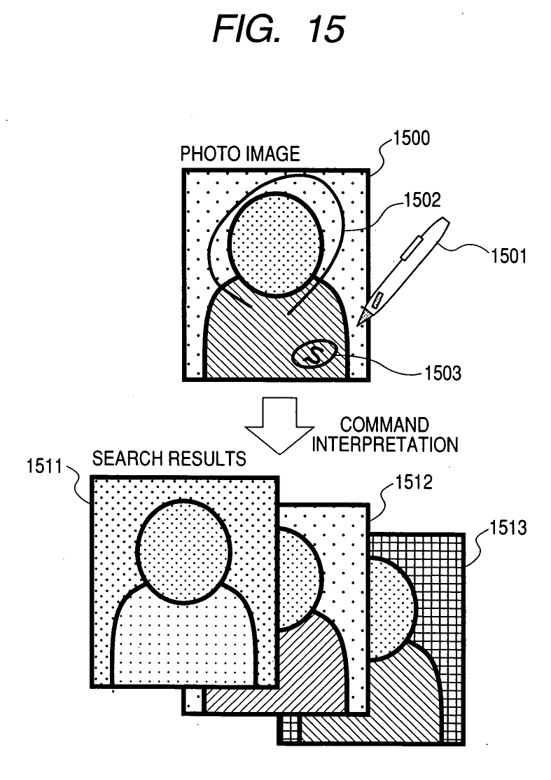

Command interpretation processing is executed by the above flow and the user instructed command can be executed. By the above processing, not only the example shown in FIG. 2 but also other examples can be responded such as a net search shown in FIG. 14, a similar image retrieval in FIG. 15 (a rounded character S is assumed to be registered meaning a “similar image retrieval”), or the like. In FIG. 14, at Step 1004, a candidate set containing the command elements of [symbol] (katakana)” and “Web search” is obtained from the round enclosure 1402 entered with a pen 1401 and a handwritten character string 1403 on a paper 1400. FIG. 10 shows an example, wherein at Step 1005, by matching the command element candidate set with the rule dictionary 500, a command interpretation candidate is obtained for net search of the [symbol] and then the command is executed at Step 1006. FIG. 15 also shows an application example, wherein an image in the area of the round enclosure 1502 is searched with a similar retrieval from the round enclosure 1502 and the sign 1503 meaning a similar retrieval written on the photograph 1500, and the photographs 1511-1513 were displayed as the result.

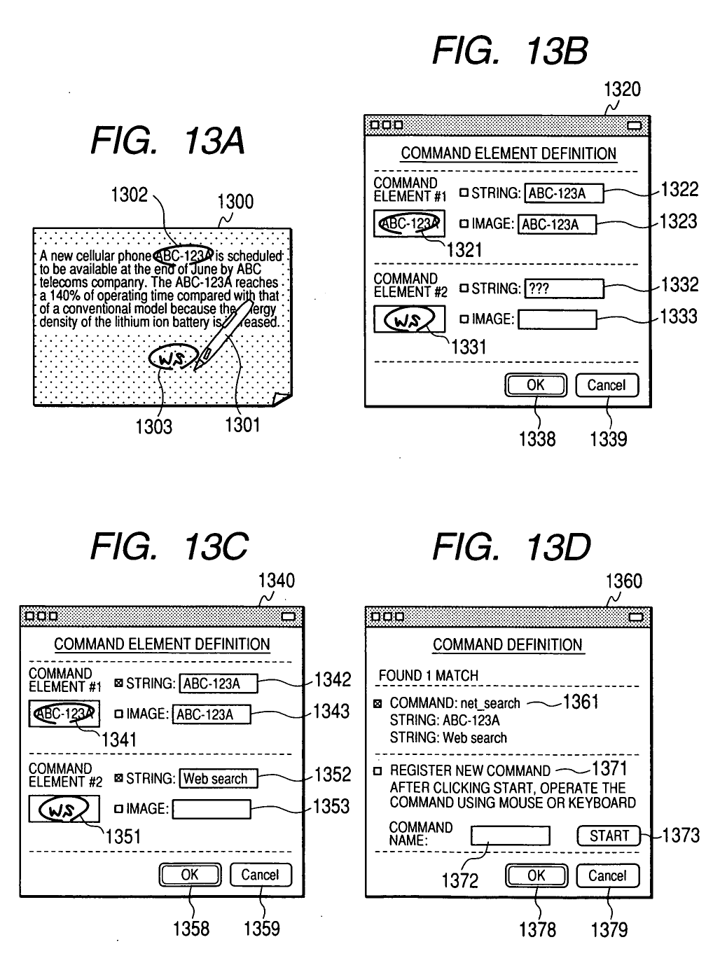

Finally, the procedure wherein a user adds a command is explained specifically. FIG. 13 shows an example wherein a gesture of a character string WS surrounded with a circle is registered as an additional command specification method for net search.

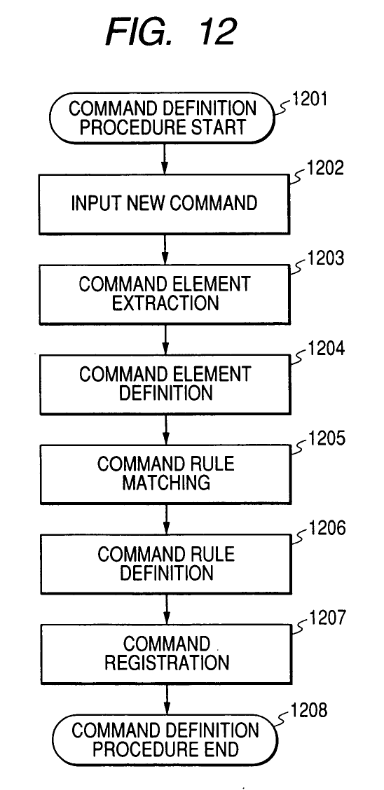

First, the mode of command interpreter 100 is set as register mode. Then, the command which a user wants to register is instructed using a paper, a pen, and the like in the same way as actually commanded (Step 1202 in FIG. 12, and in FIG. 13A).

Then, the dialog 1320 of FIG. 13B is displayed on the monitor of command interpreter. The definition of each inputted command element is determined in the dialog. As processing concerning this dialog, command extraction is first executed using the element dictionary at this time, and the extraction result of each inputted command element is obtained before displaying (Step 1203). Next, a dialog 1320 is displayed and a user ought to check and correct the intention of each command element. Since the round enclosure 1302 of the first command element is a “character string” net search is to be carried out thereto, the check box for the item 1322 on the top of the dialog is made on, and an input is entered that “ABC-123A” is a character string representing a command element. Moreover, since the gesture 1303 of the second command element is a gesture unregistered in the element dictionary at present, the recognition fails, and “???” is displayed on the item 1332. If a user corrects this by inputting with a keyboard the “Web search” which is one of the character strings of the command type element of net search, turning ON the check box of an item 1332, and inputting the character string “Web search”, an input is entered that the gesture 1303 means the command type element “Web search” (FIG. 13C). There is no error in the contents of registration is first checked, and OK button 1358 is clicked. The process by this point serves as a step of the command element definition 1204.

Next, command rule matching (Step 1205) is executed, checked whether the matching is made with the command rule registered in the present rule dictionary, and the result is displayed like the dialog 1360 of FIG. 13 (Step 1207). Since in the case of this example the command type of net search is registered in the rule dictionary as shown in FIG. 5, the result is displayed like an item 1361.A user chooses this item 1361, and if OK button 1378 is clicked, additional registration of the command wanted will be made (Step 1207).

Since the type of a command itself does not have any change in this example, there is no change in the rule dictionary, and additional registration of the stroke of WS will be carried out to the element dictionary with a rounded character (420 of FIG. 4).

Unlike the example of FIG. 13, if additional registration of the command type itself is wanted, then a new command type registration (item 1371) of a dialog 1360 is chosen and the start button 1373 is clicked after inputting a suitable command name into an item 1372. Then, with the command interpreter the tracking of the operation by the user is started, and leaves the operation record on the interpreter hereafter. The definition of each command element will be checked with the record, the instruction rule of a new command type will be determined, and will be registered in the rule dictionary.

Thus, even if a user does not master technical knowledge, such as details of command interpretation processing, and a command statement technique, a command can be easily added in the form where the actual use scene is met, by offering the command addition means using a paper and a pen.

The method for interpreting the commands of the present invention is available for use in the wide fields from business courses of supporting intellectual activities, for example, research and development, and planning thereof, to individual consumer uses, such as browsing concerning the related information on an inspection report in an individual.

What is claimed is:

1. A data entry apparatus and a program comprising:
an input unit which receives the instruction input from a user;
a command element extraction unit which outputs a plurality of recognition candidate for the command element from the instruction input;
a command rule matching unit, in which a command type element is extracted from the recognition candidates, and the command argument element is decided for the command type element, and further the combination is determined of the command type element and the command argument element; and
a command execution unit, in which the command having the command type element is executed for the command argument element.

2. The data entry apparatus according to claim 1, wherein the data entry is a writing into a medium with an electronic pen, an instruction to a display via a pointing tool, or an input to the data entry apparatus through an input device.

3. The data entry apparatus according to claim 1, wherein the command element extraction unit divides the instruction input based on at least either of the time of the input or a geometric feature for a stroke of the input, and generates a command element-unit candidate, and outputs a plurality of the recognition candidates.

4. The data entry apparatus according to claim 2, wherein the command element extraction unit divides the instruction input based on at least either of the time of the input or a geometric feature for a stroke of the input, and generates a command element-unit candidate, and outputs a plurality of the recognition candidates.

5. The data entry apparatus according to claim 3, wherein the data entry apparatus includes a command element dictionary defining a gesture and an extraction method for the gesture, and the command element extraction unit determines which of the gestures the instruction is, if the generated command element-unit candidate is either of a writing into a medium with an electronic pen or an instruction to a display via a pointing tool, and executes the instruction extraction method corresponding to the instruction determined as the gesture, and extracts the plural candidates.

6. The data entry apparatus according to claim 5, wherein the instruction extraction method either extracts the instruction part of the gesture, which cuts out the instruction part as an image, as a character string, or sets the command matched beforehand with the instruction part, and the data entry apparatus executes character recognition for the character string, if extracted, and extracts the plural candidates.

7. The data entry apparatus according to claim 1, wherein the command element extraction unit outputs the plural candidates with the reliability, the command rule matching unit determines the reliability of the combination of a command type element and a command argument element, both elements constituting the combination, based on the reliability of each element, and determines the combination based on the reliability thereof.

8. The data entry apparatus according to claim 5, wherein the reliability is calculated from the multiplication value of the degree of coincidence of the input gesture stroke with the registered stroke, and the overlap ratio of the extracted candidate with the input stroke.

9. The data entry apparatus according to claim 1, wherein the command rule matching unit determines the combination of the command type element and the command argument element based on the command rule dictionary defining the combination, and the command rule dictionary is described with the free context method.

10. The data entry apparatus according to claim 1, wherein the command element extraction unit displays the command type element extracted on a display, and receives a check or correction for the element through the input unit.

11. The data entry apparatus according to claim 1, wherein registration of a new command type element is accepted through the input unit.

12. A program for the data entry apparatus comprising the steps of:
accepting an instruction input from a user by the input unit;
outputting a plurality of recognition candidates, wherein the instruction input is divided to create a command element-unit candidate based on at least any of input time, and a geometrical feature of the input stroke;
extracting a command type element from the recognition candidates;
determining the combination of the command type element and the command argument element based on the command rule dictionary which defines the combination of a command type element and a command argument element; and
executing the command for the command type element for the determined command argument.
